(19) United States
(12) Patent Application Publication
(10) Pub. No.: US 2007/0038754 A1
(43) Pub. Date: Feb. 15, 2007

(54) Open-innovation network

(76) Inventors: Enrique Nunez, Nutley, NJ (US); Miguel Perez, Little Falls, NJ (US)

Correspondence Address: PATENT DOCKET ADMINISTRATOR;LOWENSTEIN SANDLER PC, 65 LIVINGSTON AVENUE, ROSELAND, NJ, 07068, US

(21) Appl. No.: 11/503,361

(22) Filed: Aug. 11, 2006

Related U.S. Application Data
(60) Provisional application No. 60/707,342, filed on Aug. 12, 2005.

(51) Int. Cl. G06F 15/173

(52) U.S. Cl. 709/226; 709/243

(57) ABSTRACT

An Open-Innovation Network wherein an Intermediary facilitates the research, creation and exchange (e.g., sale or license) of digital media (i.e., “Digital Innovations”). The Intermediary may participate in both the design and development of the Digital Innovations, and also acts as a broker between individuals or entities seeking to license or purchase the Digital Innovations. The Open-Innovation Network provides substantial value in a unique manner for those producing the digital media, as well as those licensing or purchasing said digital media.

### CROSS REFERENCE TO RELATED APPLICATION

This application claims the benefit of U.S. Provisional Application Ser. No. 60/707,342 filed on Aug. 12, 2005. The entire disclosure of U.S. Provisional Application Ser. No. 60/707,342 is incorporated by reference herein.

### FIELD OF THE INVENTION

The present invention relates to a system and method for research, creation, marketing and exchange (e.g., sale and/or license) of digital media through a collaborative network-based electronic marketplace.

### BACKGROUND OF THE INVENTION

Historically, only large firms could compete in sectors that required massive expenditures on research and development (R&D). These enormous in-house expenditures also became daunting barriers to entry for would-be competitors, as challengers would have to develop their own in-house capabilities in order to compete.

However, the same firms that had invested massive amounts of resources on in-house R&D efforts have in recent times, wrestled with a dual challenge. Many of these firms have encountered fierce competition from upstarts that conduct little or no basic research of their own, while their own in-house R&D efforts fail to translate into economic returns. Consequently, many firms are seeking to generate innovation by tapping into outside expertise through a process known as open innovation.

Open innovation dictates that R&D should extend beyond the boundaries of the firm. Specifically, firms should cultivate outside ideas to advance their own business agendas, while leveraging internal ideas outside their current operations. Thus, open innovation offers an improved way to build value, and new opportunities to claim portions of that value.

Open innovation has been studied in various forms, with a significant amount of analysis conducted on the “open-source movement”—the software production model that leverages the distributed intelligence of a global community of software developers.

Related research has focused on various characteristics of the user innovator community, such as the leaders who coordinate the tasks of community members, lead users whose needs foreshadow general demand in the marketplace, user innovator incentives to encourage knowledge creation, and mechanisms by which community innovators obtain resources and assistance from the community. Other associated research has dealt with the issue more generally, such as managing the open innovation process, outsourcing innovation, and amateur innovation by enthusiasts.

User innovator communities, from which outside ideas may be harvested will always develop. If not explicitly created and controlled by firms, these communities will develop organically—and can be the source of significant innovation (e.g., Lego's Mindstorms community grew rapidly without firm involvement and helped exceed sales expectations), and customer loyalty (e.g., Harley Davidson's H.O.G. community helps ensure loyalty to the firm and its products), or immeasurable frustration (e.g., AT&T was plagued in the 1960s and 70s by phone phreaks—users who illegally manipulated the phone system).

For firms interested in open innovation, this suggests that it may be in the firm's best interest to actively create and leverage its user community. Nevertheless, direct control by firms attempting to manage open innovation can be costly and complex.

As such, there is a need in the art for a method and system which mitigates the above-described problems by facilitating the creation of digital media.

### SUMMARY OF THE INVENTION

The present invention relates to a system and method for a network-based electronic marketplace (herein the “Open-Innovation Network”) comprising an Intermediary configured to facilitate the creation of digital media and act as a broker between those that seek to license or purchase the media (i.e., Innovation-Seekers) and those that create the media (i.e., Solution-Providers).

According to an embodiment of the present invention, the Intermediary facilitates the research, creation, marketing and sale of digital media or “Digital Innovations” (i.e., the practical realization of a new or improved and useful idea, that is fully manifest as an individual or group of digital files and that has been created with the aim of entertainment and/or improving efficiency or effectiveness).

According to an embodiment of the present invention, the Intermediary may design and develop the Digital Innovations, and further act as a broker between the Innovation-Seekers and the Solution Providers.

According to an embodiment of the present invention, the Open-Innovation Network is a computer-based system which may include, but is not limited to, a combination of off-the-shelf software components. Advantageously, the Intermediary provides community leadership and incentives to encourage creation of the Digital Innovations. In addition, the Intermediary may provide screening mechanisms for reviewing the Digital Innovations, and provides for the exploitation (e.g., extraction of monetary value) of the Digital Innovations; and the method by which said Digital Innovations are assessed, marketed, and distributed.

According to an embodiment of the present invention, the system allows individuals interested in creating Digital Innovations a unique way to: join a targeted community of individuals or entities to share common interests, create a team consisting of other community members, search for Projects or develop Projects of their own creation, collaboratively develop and test Digital Innovations, provide performance feedback, transfer said Digital Innovations to Intermediary-controlled computer servers, and extract monetary value from said Digital Innovations.

According to an embodiment of the present invention, the system allows individual users, a group of individuals, individual legal entities, or a group of legal entities a unique way to: broadcast to a plurality of Solution-Providers a request for the creation of an Digital Innovations, as well as a unique way to: search for, assess, and license or purchase said Digital Innovations.

### BRIEF DESCRIPTION OF THE DRAWINGS

The present invention will be more readily understood from the detailed description of exemplary embodiments presented below considered in conjunction with the attached drawings, of which:

FIG. 1 illustrates an exemplary Open-Innovation Network, according to an embodiment of the present invention;

FIG. 2 is a workflow diagram showing a flow of operation of an exemplary embodiment of the present invention; wherein an Innovation-Seeker defines and submits a request for solution to a Need-Based Problem;

FIG. 3 is a workflow diagram showing a flow of operation of an exemplary embodiment of the present invention wherein an Innovation-Seeker defines and submits a request for Guidance;

FIGS. 4a and 4b are workflow diagrams showing a flow of operation of an exemplary embodiment of the present invention wherein a Solution-Provider creates a New-to-the-World Innovation;

FIG. 5 is a workflow diagram showing a flow of operation of an exemplary embodiment of the present invention wherein a Solution-Provider initiates a new Project;

FIG. 6 illustrates an exemplary process for conducting system testing of a final solution;

FIG. 7 illustrates an exemplary process for examining and assessing of a final solution by Innovation-Seekers to ensure said solution meets criteria set forth by a Problem, or is otherwise commercially valuable, according to an embodiment of the present invention;

FIG. 8 illustrates an exemplary system architecture of the Open-Innovation Network, according to an embodiment of the present invention.

It is to be understood that the attached drawings are for purposes of illustrating the concepts of the invention and may not be to scale.

### DETAILED DESCRIPTION OF THE INVENTION

Provided below is a glossary of terms used in the present application. The scope of the present invention is not to be deemed limited by the definitions.

“Abstract”—includes, but is not limited to, an abbreviated Innovation-Seeker description of a Need-Based Problem developed by an Innovation-Seeker, or an abbreviated description of an Innovation developed by a Solution-Provider.

“Acceptance-Test” or “Acceptance Testing”—includes, but is not limited to, the examining and assessing of Innovations by Innovation-Seekers in the Staging Area to ensure said Innovations meet criteria set forth by the Need-Based Problem, or are otherwise commercially valuable (as would be the case with New-to-the-World Innovations).

“Alert”—includes, but is not limited to, a communication or communication system (e.g., an email-based system) that allows a Liaison and registered users to set criteria and be notified when criteria is met.

“Candidate-Innovation”—includes, but is not limited to, an Innovation that has not yet been purchased and resides in the Staging-Area. The Candidate Innovation may be deemed by a Liaison to have met all criteria set forth by the Need-Based Problem, or, alternatively, it may be a New-to-the-World Innovation that an Innovation-Seeker wishes to test.

“Collaboration”—includes, but is not limited to, an act of Innovation-Seekers, Liaisons, and Solution-Providers cooperating electronically to develop an Innovation using the Collaboration Functionality of the Open-Innovation Network.

“Collaboration Functionality”—the workflows and electronic tools provided by the Open-Innovation Network which facilitate the Collaboration, which include, but are not limited to: Gantt charts, a document management system with the ability to support various file types, instant messaging/chat, blog (web log), shared calendar, and a version control system.

“Community”—includes, but is not limited to, an Open-Innovation Network controlled computer environment whereby a broad range of individuals or entities that share a common interest may interact electronically, using computer-based tools, such as, for example, a Discussion Forum. According to an embodiment of the present invention, the Communities may be composed of a plurality of sub-communities.

“Computer”—includes, but is not limited to, any data processing device, such as a desktop computer, a laptop computer, a mainframe computer, a personal digital assistant, a server, a handheld device, or any other device able to process data.

“Development Team”—includes, but is not limited to, a plurality of Solution-Providers collaborating to create a specific New-to-the-World Innovation or a Solution to a Need-Based Problem.

“Direct-Link” or “Direct-Link System”—includes, but is not limited to, an embodiment of the present invention wherein Innovation-Seekers may select the Solution-Providers that work on or create a Solution to their request for Innovation. See also: In-House Services, Open-Link.

“Discussion Forum”—includes, but is not limited to, a general threaded discussion forum (i.e., not Project specific) that may be read by individuals accessing the Open-Innovation Network. According to an embodiment of the present invention, a registered user may be permitted to post general messages to the Discussion Forum.

“Electronic Media” or “Digital Media”—includes, but is not limited to, media based on digital codes, wherein the digital codes are represented by the binary numeral system. According to an embodiment of the present invention, the digital media may include, for example, digital audio, digital video, and other digital “content” that may be created, referred to and distributed via digital information processing machines or computers.

“End Date”—includes, but is not limited to, the date which a Candidate-Innovation is targeted for completion, posted to the Staging Area, and ready for examination by an Innovation-Seeker.

“Expiration Date”—is a characteristic of a Problem, which includes, but is not limited to, the due date imposed on a Solution-Provider by which they must create a Project with the intention of working on a specific Problem.

“Expired Problem”—A Problem that is no longer visible and can no longer be worked on by Solution-Providers because no Solution-Providers have initiated a Project by the Problem's Expiration Date.

“Expired Solution”—A Solution that has been deemed by a Liaison to have met all problem criteria, but has not been purchased by an Innovation-Seeker by the specified End Date and has therefore reverted back to inventory.

“Guidance”—includes, but is not limited to, “areas of interest” identified by Innovation-Seekers. According to an embodiment of the present invention, Solution-Providers may use the Guidance to ascertain whether commercial interest exists for a potential New-to-the-World Innovation.

“In-House Services” or “In-House Services System”—includes, but is not limited to, an embodiment of the present invention wherein an Intermediary designs, develops, manages, and/or leads the design and/or development of the Innovations—thus acting as an internal Solution-Provider/Project Champion. According to embodiment of the present invention, the In-House Services may utilize outside Solution-Providers to augment Development Teams. See also: Direct-Link, Open-Link.

“Innovation” or “Digital Innovation”—includes, but is not limited to, the realization of a new or improved and useful idea, that is fully manifest as an individual or group of digital files (e.g., text, image, video, animation, or audio files).

“Innovation-Seeker”—includes, but is not limited to, an individual user, group of individuals, legal entity, or group of legal entities that have registered with the Open-Innovation Network and seeks to license or purchase Innovations.

“Intermediarv” or “Liaison”—includes, but is not limited to, an entity in the Open-Innovation Network that works with Innovation-Seekers and Solution-Providers to design Innovations, source their development, and arrange for their delivery. According to an embodiment of the present invention, the Intermediary may utilize In-House Services, or may act as a “trusted broker” between Innovation-Seekers and outside Solution-Providers by: providing toolsets to help with Innovation development, a mechanism to verify Innovation results, community leadership to ensure order and quality, creating incentives for system participation, establishing screening mechanisms for contributors, ensuring rival options are given adequate consideration, and establishing methods by which Solution-Providers can extract monetary value from the creation of Innovations.

“Inventorv”—includes, but is not limited to, a designated area on a restricted Open-Innovation Network computer server that stores Expired Solutions and Innovations that have not been purchased.

“Marketspace”—includes, but is not limited to, a specific industry within which an Open-Innovation Network will be implemented (e.g., software, financial, and music industries) with the objective of facilitating the development of Innovations by Solution-Providers for that industry's Innovation-Seekers.

“Monetize”—A term that describes the extraction of monetary value from an Innovation.

“Need-Based Problem” or “Problem”—includes, but is not limited to, a specific problem that an Innovation-Seeker requests help in solving. According to an embodiment of the present invention, the Need-Based Problem including the criteria for solving the problem is posted by the Innovation-Seeker onto the Open-Innovation Network in a detailed manner (including the expected outcome).

“New-to-the-World Innovation”—includes, but is not limited to, an Innovation that was developed independent of a specifically communicated Problem (i.e., not in response to a Need-Based Problem). According to an embodiment of the present invention, New-to-the-World Innovations may be developed in response to one or more Guidances provided by one or more Innovation-Seekers, or independently developed and later matched with a Guidance in order to identify a potentially interested Innovation-Seeker.

“Open-Innovation Network”—includes, but is not limited to, a system wherein an Intermediary facilitates the research, creation and sale of Innovations. According to the present invention, the Open-Innovation Network has three primary embodiments, referred to as In-House Services, Direct-Link, and Open-Link.

“Open-Link” or “Open-Link System”—A manifestation of the present invention whereby Innovation-Seekers capture value from Innovations along three dimensions: No Risk/Cost-Effective/Differentiated. Aside from an annual subscription fee, Innovation-Seekers assume no risk for the development of Innovations, may assess Innovations before purchasing, and subsequently only pay for those Innovations they accept. Solution-Providers' limited overhead coupled with marketplace dynamics results in cost-effective Innovations. Innovations are developed by a potentially vast pool of talented Solution-Providers resulting in differentiated (i.e. distinct, non-commodity) offerings. See also: In-House Services, Direct-Link.

“Portfolio”—includes, but is not limited to, a grouping of problems or Innovations.

“Post”—includes, but is not limited to, an electronic transferring of files onto the Open-Innovation Network.

“Profile”—includes, but is not limited to, a grouping of Open-Innovation Network defined taxonomy fields that are used for classification and search. According to an embodiment of the present invention, a profile may be specifically designed for a particular aspect of the Open-Innovation Network, such as, for example, a registered user, an Innovation, a Solution, etc.

“Project” —An effort initiated by a Solution-Provider with the objective being to develop an Innovation.

“Project Champion”—includes, but is not limited to, the designation given to the Solution-Provider or Intermediary that coordinates the performance of a Project and/or Solution, and further manages the Development Team.

“Project Forum”—includes, but is not limited to, a Project-specific threaded discussion forum that is used as a means of collaborating among Project members (i.e., Development Team, Liaisons, Innovation-Seekers).

“Rankings”—includes, but is not limited to, an Open-Innovation Network-provided system for performance feedback.

“Registered User”—includes, but is not limited to, any individual user, group of individuals, legal entity, or group of legal entities that have registered with the Open-Innovation Network, such as, for example, an Innovation-Seeker and a Solution-Provider.

“Search”—includes, but is not limited to, a function provided by the Open-Innovation Network wherein full text, keyword, or other like search may be performed.

“Solution”or “Final Solution”—includes, but is not limited to, a Solution-Provider developed Innovation that was created in response to a request for a Need-Based Problem.

“Solution-Provider”—includes, but is not limited to, an individual user, group of individuals, legal entity, or group of legal entities that have experience and/or training useful to a Marketspace, have registered with the Open-Innovation Network, and intend to develop and/or post Innovations. According to an embodiment of the present invention, a Solution-Provider may act as a Project Champion and/or a Team Member.

“Staging Area”—includes, but is not limited to, a designated area on the Open-Innovation Network for the performance of Acceptance Testing of an Innovation, Solution or Candidate-Innovation.

“System Test”—includes, but is not limited to, the performance of steps to confirm the correctness and interoperability of Final Solutions provided by at least one Solution-Provider.

“Task”—includes, but is not limited to, a unit of work that is generally assigned to a Development Team member by the Project Champion. According to an embodiment of the present invention, a Project may comprise a plurality of individual Tasks.

“Test”—A general term for a workflow phase wherein Innovations are examined and assessed on Open-Innovation Network computer servers. Includes Acceptance-Test and System Test.

“Team Member”—includes, but is not limited to, a Solution-Provider that is part of a Development Team.

“Toolset”—includes, but is not limited to, one or more electronic tools, preferably provided by the Open-Innovation Network, designed to help Solution-Providers with the development of Innovations.

“Value-Multiplier”—A term that describes the unique value offered to Innovation-Seekers and Solution-Providers through the use of the Open-Innovation Network. According to an embodiment of the present invention, with respect to Innovation-Seekers, value is imparted primarily along the three manifestations of the present invention: In-House Services, Direct-Link, and Open-Link. According to an embodiment of the present invention, with respect to Solution-Providers, value is conveyed by providing: a mechanism to monetize ideas and develop a reputation while not working directly for a firm; access to a Community, as well as a large pool of talented potential collaborators; and assistance validating, researching, refining and implementing ideas with the help of colleagues (e.g., Community), industry participants (e.g., Liaisons, Innovation-Seekers), and toolsets.

“Visitor”—Any visitor to the Open-Innovation Network website.

“Workflow”—includes, but is not limited to, a set of states, state transitions, rules, and actions, determined by the Open-Innovation Network, that Innovation-Seekers, Liaisons and Solution-Providers must follow during the development of Innovations (see examples); wherein

a “State” includes, but is not limited to, information that is accessible or viewable by a registered user when in a particular situation, as well as the allowable State Transitions;

a “State Transition” includes, but is not limited to, a set of Rules that causes the workflow to move into a different state, as well as define any actions that are to be taken when moving from the current state;

a “Rule” may allow the system to compare values. According to an embodiment of the present invention, if all the rules evaluate to true, then a transition is made, otherwise the workflow remains in its current state.

an “Action” may be used to dynamically retrieve information to be evaluated. According to an embodiment of the present invention, an action may be performed on state entry and state exit, and may be an element within a rule.

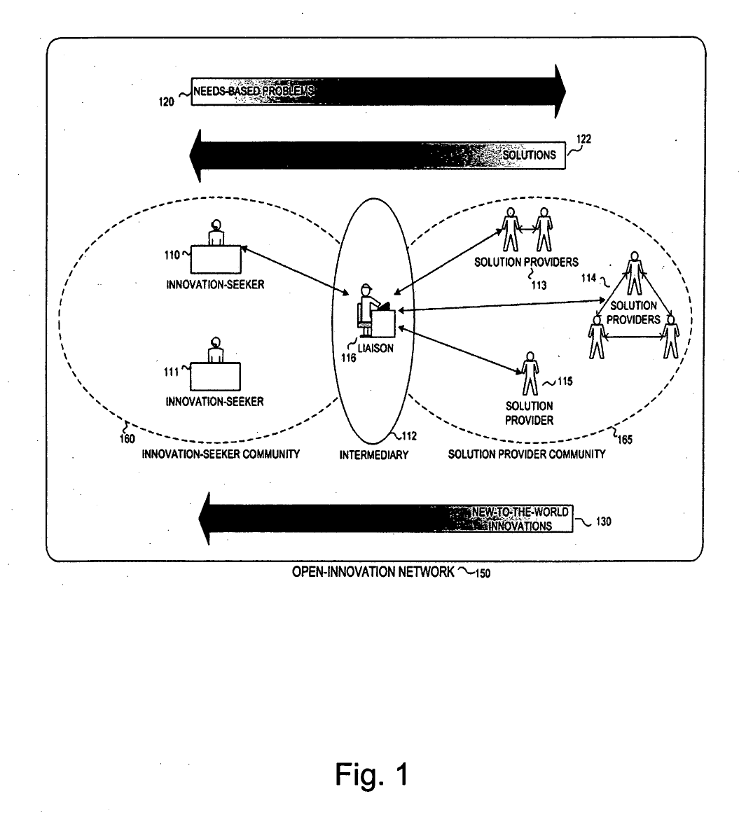

The present invention is described below with reference to FIGS. 1-8. FIGS. 1-8 are intended to illustrate exemplary embodiments of the present invention. One having ordinary skill in the art will appreciate that alternative embodiments may be used and are within the scope of the present invention.

The following detailed description is divided into three sections. In the first section, the preferred embodiment of the present invention: the Open-Innovation Network is described. In the second section, the process for using the preferred embodiment of the present invention is described using six examples. Finally, in the third section, an exemplary embodiment of the system architecture in which the preferred methods of the invention may be practiced is described.

Section 1: A Description and Operation of the Method and System of the Invention

A method and system of the present invention is described below in conjunction with FIG. 1. FIG. 1 depicts an Open-Innovation Network 150 comprising an Innovation-Seeker Community 160, an Intermediary 112, and a Solution-Provider Community 165. According to an embodiment of the present invention, the Innovation-Seeker Community 160 comprises a plurality of Innovation-Seekers 110, 111, wherein the Innovation-Seekers 110, 111 are those individuals, companies, legal entities, universities, etc. which seek the creation of one or more Innovations. The Solution-Provider Community 165 comprises a plurality of Solution-Providers 113, 114, 115, wherein the Solution-Providers 113, 114, 115 are those individuals or groups which have experience and/or training useful to a Marketspace and intend to develop and/or post Innovations.

According to an embodiment of the present invention, the Open-Innovation Network 150 is a network-based marketplace wherein an Intermediary 112 facilitates the creation of digital media and may act as a broker between the Innovation-Seekers 110, 111 (i.e., those seeking the creation of Innovations) and Solution-Providers 113, 114, 115 (i.e., those that create said media). According to an embodiment of the present invention, the Open-Innovation Network 150 facilitates the discovery, development, screening and transfer of Innovations.

As described herein, the Open-Innovation Network 150 has three primary embodiments: the In-House Services System, the Direct-Link System, and the Open-Link System.

According to the In-House Services System embodiment of the present invention, the Intermediary 112 is configured to design, develop, and manage the creation of the Solutions. According to the Direct-Link System embodiment of the present invention, the Innovation-Seekers 110, 111 select the Solution-Providers 113, 114, 115 to develop the requested Innovation.

According to the Open-Link System embodiment of the present invention, the Intermediary 112 (enabled through a Liaison 116) acts as a broker between the Innovation-Seekers 110, 111 and the potential Solution-Providers 113, 114, 115. As such, in this embodiment, the Solution Providers 113, 114, 115 select which Problems to work on.

In all of the above-described embodiments, the Intermediary 112 may provide a toolset to facilitate the Innovation development, a mechanism to verify Innovation results, community leadership (for both Innovation-Seekers 110, 111 and potential Solution-Providers 113, 114, 115). In addition, the Intermediary 112 may also help define incentives for network participation, develops and enforces screening mechanisms for community participants, provides mechanisms for escrow and payment services, extract rents from transactions, and maintains the network.

Referring to FIG. 1, the Open-Innovation Network 150 enables the development of Solutions 122 to specific client needs (i.e., Need-Based Problems 120), as well as the development of New-to-the-World Innovations 130. Thus, innovation may originate with either the Innovation-Seekers 110, 111 or the Solution-Providers 113, 114, 115.

According to an embodiment of the present invention, Need-Based Problems 120 are specific problems that Innovation-Seekers 110, 111 request help in solving (i.e., by the creation of a Solution 122). Generally, the criterion for solving these types of problems is posted by Innovation-Seekers 110, 111 onto the Open-Innovation Network 150 in a detailed manner. According to an embodiment of the present invention, for a Need-Based Problem 120, the Innovation-Seekers 110, 111 may determine adequate compensation for Solutions 122 that successfully meet their criteria for success.

For example, an Innovation-Seeker 110 may begin the process of resolving a specific problem by working with the Intermediary 112 (i.e., via a Liaison 116) to define the Need-Based Problem 120, and, optionally, sets a maximum price for a successful Solution 122.

Once the problem has been adequately defined, the Innovation-Seeker 110 may post the problem via the Intermediary 112, optionally in an anonymous manner, to the Solution-Provider Community 165. According to the Direct-Link embodiment of the present invention, based at least on the nature of the problem (i.e., the technical aspects of the problem), the Intermediary may prescreen and request that one or more Solution-Providers 113, 114, 115 in the Community 165 work on the particular problem at hand. In addition, the Intermediary 112 may interact with the Solution-Providers 113, 114, 115 to refine the Solutions 122.

According to an embodiment of the present invention, the Intermediary 112 may refine the Solution based at least in part on prior experience with the problem type and/or with the Innovation-Seeker 110, or based upon a review of the project documentation.

Once the Solutions 122 are finalized (i.e., a Final Solution is created), a number of Candidate Solutions may be presented to the Innovation-Seeker 110, allowing the Innovation-Seeker 110 to review and select one or more desired Solutions 122.

According to an embodiment of the present invention, the exchange of New-to-the-World Innovations 130 (i.e., Innovations that Solution-Providers 113, 114, 115 develop independent of any specifically communicated problem) is managed by the Intermediary 112. According to this embodiment, the Intermediary 112 may negotiate licensing or outright sale of New-to-the-World Innovations 130 with the Innovation-Seekers 110, 111, or terms for licensing or outright sale may be negotiated directly by the Solution-Provider 113, 114, 115 that developed the Innovation.

According to an embodiment of the present invention, the Open-Innovation Network 150 allows the Innovation-Seekers 110, 111 to obtain Solutions 122 and New-to-the-World Innovations 130 from Solution-Providers 113, 114, 115 after the results and interoperability of the Innovation has been tested and established. As such, the Intermediary 112 verifies that the Innovation meets the needs of the Innovation-Seeker 110, 111. Innovation-Seekers 110, 111 further benefit by having access to a potentially vast pool of leading talent that provides novel ideas, and by providing a mechanism to extend investment in existing systems and satisfy capacity issues without hiring additional staff. Thus, the Open-Innovation Network 150 enables the Innovation-Seekers 110, 111 to generate higher-value innovation by drawing on knowledge distributed geographically.

According to an embodiment of the present invention, the Open-Innovation Network 150 enables the Solution-Providers 113, 114, 115 an opportunity to work on real problems, a means to develop a reputation while not working directly for a firm, a means to monetize ideas, access to Innovation-Seekers 110, 111, a simplified interface and workflows allowing focus to remain on developing Solutions 122 and New-to-the-World Innovations 130, a repository allowing quick access to past work, help refining and validating Solutions 122 and New-to-the-World Innovations 130 with industry experts, access to a large pool of talented collaborators, and a sense of community. For potential Solution-Providers 113, 114, 115, the Open-Innovation Network 150 offers an efficient and financially attractive method to make the most of their expertise.

Section 2: Exemplary Methods and Systems According to the Present Invention

This section provides examples illustrating the systems and methods of the present invention. Example 1 describes the operation of an exemplary embodiment of the present invention wherein an Innovation-Seeker defines a new Need-Based Problem, according to an embodiment of the present invention. Example 2 describes the operation of an exemplary embodiment of the present invention wherein an Innovation-Seeker defines and submits a Guidance, according to an embodiment of the present invention. Example 3 describes the operation of an exemplary embodiment of the present invention wherein a Solution-Provider creates a New-to-the-World Innovation, according to an embodiment of the present invention. Example 4 describes the operation of an exemplary embodiment of the present invention wherein a Solution-Provider initiates a new Project, according to an embodiment of the present invention. Example 5 describes the operation of exemplary embodiment of the present invention wherein a Solution-Provider system-tests a Solution to a previously defined Innovation-Seeker Problem, according to an embodiment of the present invention. Example 6 describes the operation of exemplary embodiment of the present invention whereby an Innovation-Seeker acceptance-tests a Solution, according to an embodiment of the present invention.

### EXAMPLE 1

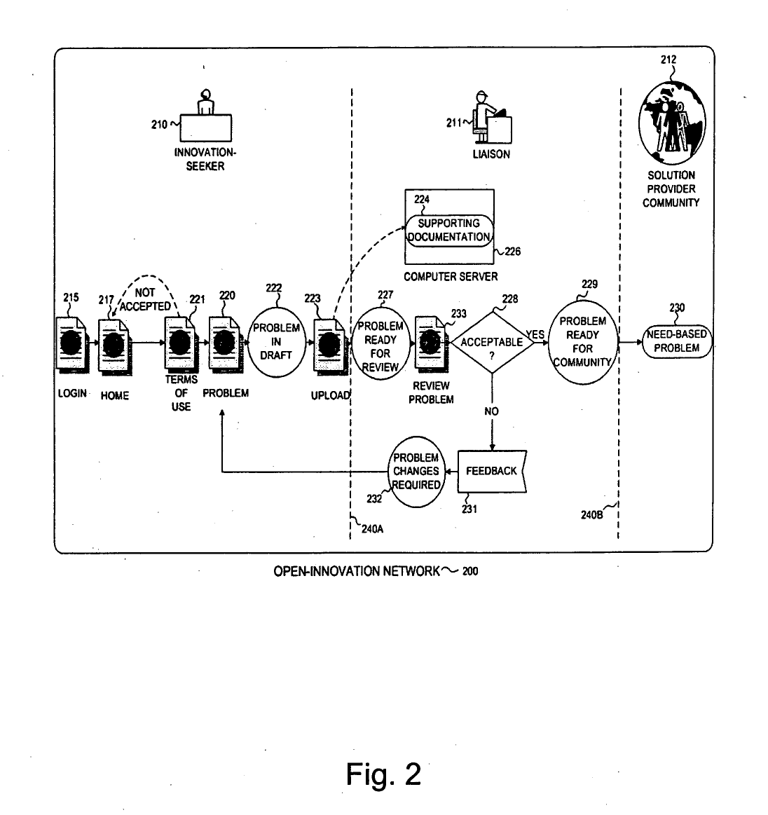

Example 1 is described in connection with FIG. 2. FIG. 2 depicts a workflow diagram showing a flow of operation of an exemplary embodiment of the present invention wherein an Innovation-Seeker defines a new Need-Based Problem. The two straight dotted lines 240a, 240b depict a delineation of responsibilities between the Innovation-Seeker 210, the Liaison 211, and the Solution-Provider community 212.

As shown in FIG. 2, an Innovation-Seeker 210 navigates the Internet or other suitable network to the Login interface 215 of the Open-Innovation Network 200. According to an embodiment of the present invention, the Innovation-Seeker 210 may log into the Open-Innovation Network 200 using a previously assigned system username and/or password.

Once logged in, the Innovation-Seeker 210 is presented with the Home page 217 that provides a “New Problem” button or link. The Innovation-Seeker 210 clicks on a “New Problem” button or link on the Home page 217. The Innovation-Seeker 210 is then presented with a Terms of Use page 221 that details the conditions under which the Innovation-Seeker 210 is agreeing to use the system. The Terms of Use page 221 may require that the Innovation-Seeker 210 click “Accept” or “Do Not Accept,” in order to advance to the next stage of the process.

If the Innovation-Seeker 210 clicks “Do Not Accept”, he or she is returned to the Home page 217 and presented with a message indicating that he or she may not enter a problem into the Open-Innovation Network 200 without first agreeing to the conditions for system use and is given the choice of returning to the Home page 217.

If the Innovation-Seeker 210 clicks “Accept” on the Terms of Use page 221, he or she is then presented with a form for entering a request for the creation of an Innovation, referred to as the Problem page 220, which may include, but is not limited to, the following exemplary fields:

TABLE 1
Exemplary Problem page 220

| Field | Field Description |
|---|---|
| Problem Id | A unique problem id. |
| Title | The problem title. |
| Description | A detailed Need-Based Problem description (including the expected |
| | outcome). Alternatively, this field can be used for an abstract, while |
| | longer descriptions can be uploaded as Supporting Documentation 224. |
| Terms and | The terms and conditions under which a Solution to this problem will be |
| Conditions | accepted (e.g. details of license or purchase agreements), as well as the |
| | monetary amount to be disbursed by the Innovation-Seeker upon acceptance |
| | of a Solution. |
| End Date | The date by which a Candidate-Innovation will be completed and ready |
| | for examination by an Innovation-Seeker. |
| Keywords | Searchable full text keywords that will facilitate the discovery of this |
| | problem by qualified Solution-Providers. |
| Profile | This will encompass a number of Open-Innovation Network defined |
| (Taxonomy | industry and problem specific fields to be used for further classifications |
| Fields) | (e.g. Music Genre, Required Instrumentation, etc.). |

Fields in italics are system-generated. All others are input by the user.

Once the fields on the Problem page 220 are completed and/or populated, the Innovation-Seeker 210 clicks on a “Submit” button. At this point, the system places the Problem into “Problem in Draft” status 222.

The Innovation-Seeker 210 is then presented with the Upload page 223, which may be used to upload additional files such as, for example, a lengthy, fully detailed problem description, herein referred to as Supporting Documentation 224, onto a computer or server 226 of the Intermediary/Liaison 211. Example 6 describes in greater detail the process of uploading Supporting Documentation 224.

Once the Innovation-Seeker 210 has completed uploading files (or if he or she elects not to upload additional files), he or she clicks the “OK” button on the Upload page 223. At this point, the system places the Problem into “Problem Ready for Review” status 227 and a Liaison 211 with the appropriate expertise (which is determined primarily by the Problem's profile as indicated on the Problem page 220) is alerted by the system that a new Problem is awaiting review.

According to an embodiment of the present invention, the Liaison 211 logs into the Review Problem page 233 after receiving the new Problem alert. The Liaison 211 reviews 228 the problem to determine if the problem or request for the creation of digital media is “acceptable” by considering criteria including, but not limited to: completeness, clarity, solvability and/or commercial potential.

If the problem is unacceptable (e.g., not sufficiently described or defined), the Liaison 211 may provide feedback 231 indicating how the problem may be made acceptable, and clicks on “Not Accepted” button on the Review Problem page 233. At this point, the system places the Problem into “Problem Changes Required” status 232 and the system alerts the Innovation-Seeker 210 that the problem must be modified to place it in condition for acceptance.

Once alerted that changes are required, the Innovation-Seeker 210 accesses the Problem page 220, which may be pre-populated with problem values and includes feedback 231. Once the Innovation-Seeker 210 has completed changes to the problem and the Supporting Documentation 224 has been uploaded (if necessary) using the Upload page 223, the system places the Problem back into “Problem Ready for Review” status 227 and the workflow continues as before.

Once the problem is acceptable, the Liaison 211 clicks on “Accepted” button on the Review Problem page 233. At this point, the system places the problem into “Problem Ready for Community” status 229, which makes the Problem 230 available to the entire Solution-Provider community 212, by transferring of the problem description onto an Open-Innovation Network 200 computer server (not shown) where it may be accessed by the Solution-Provider community 212.

### EXAMPLE 2

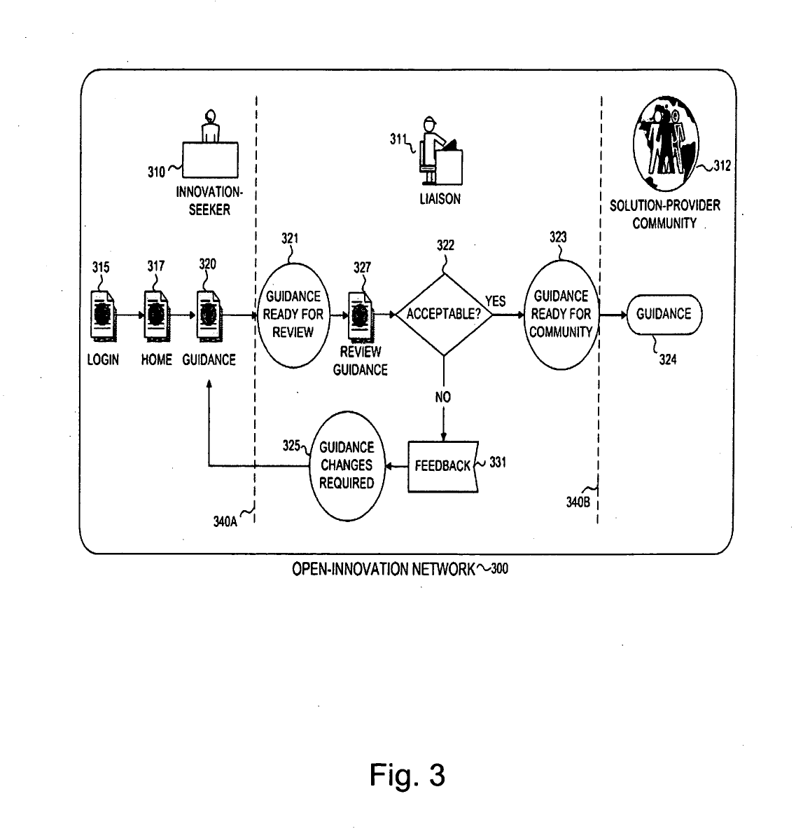

This example is illustrated in FIG. 3. FIG. 3 depicts a workflow diagram showing a flow of operation of an exemplary embodiment of the present invention wherein an Innovation-Seeker defines the Guidance. The two straight dotted lines 340A, 340B depict a delineation of responsibilities between the Innovation-Seeker 310, the Liaison 311, and the Solution-Provider Community 312.

As shown in FIG. 3, an Innovation-Seeker 310 navigates the Internet or other network to the Login page 315 of the Open-Innovation Network 300. The Innovation-Seeker 310 may then log into the Open-Innovation Network 300 using a previously assigned username and/or password.

Once logged in, the Innovation-Seeker 310 is presented with the Home page 317 which contains a “New Guidance” button or link. The Innovation-Seeker 310 clicks on a “New Guidance” button or link on the Home page 317.

The Innovation-Seeker 310 is then presented with a Guidance page 320, which may include, but is not limited to, the following exemplary fields:

TABLE
Representative Guidance page 320

| Field | Field Description |
|---|---|
| Guidance Id | A unique Guidance id. |
| Title | The Guidance title. |
| Description | Narrative describing general areas of commercial interest. |
| Keywords | Searchable full text keywords that will facilitate the |
| | discovery of this Guidance by qualified Solution-Providers. |
| Profile | This will encompass a number of Open-Innovation Network |
| (Taxonomy | defined industry and Guidance specific fields to be used |
| Fields) | for further classifications. |

Fields in italics are system-generated. All others are input by the user.

Once Innovation-Seeker 310 completes the open fields on the Guidance page 320, he or she clicks on a “Submit” button. At this point, the system places the problem into “Guidance Ready for Review” status 321 and a Liaison 311 with the appropriate expertise (which is determined primarily by the Guidance as indicated on the Guidance page 320) is alerted by the system that new Guidance is awaiting review.

After receiving the new Guidance, the Liaison 311 then accesses the Review Guidance page 327. As shown in step 322, the Liaison 311 reviews the Guidance to determine if it is “acceptable,” by considering criteria including, but not limited to: completeness, clarity and commercial potential.

If the Guidance is unacceptable, the Liaison 311 provides Feedback 331 indicating how the Guidance may be made acceptable, and clicks on “Not Accepted” button on the Review Guidance page 327. At this point, the system places the Guidance into “Guidance Changes Required” status 325 and the system alerts the Innovation-Seeker 310 that the Guidance must be modified before being accepted.

Once alerted that changes are required, the Innovation-Seeker 310 logs into the Guidance page 320. Once Guidance changes are complete, the system places the Guidance back into “Guidance Ready for Review” status 321 and the workflow continues as before.

Once the Guidance is acceptable, the Liaison 311 clicks on “Accepted” button on the Review Guidance page 327. At this point, the system places the Guidance into “Guidance Ready for Community” status 323 which makes the Guidance 324 available to one or more Solution-Providers by allowing access to the Guidance description by all or a portion of the Solution-Provider community 312.

### EXAMPLE 3

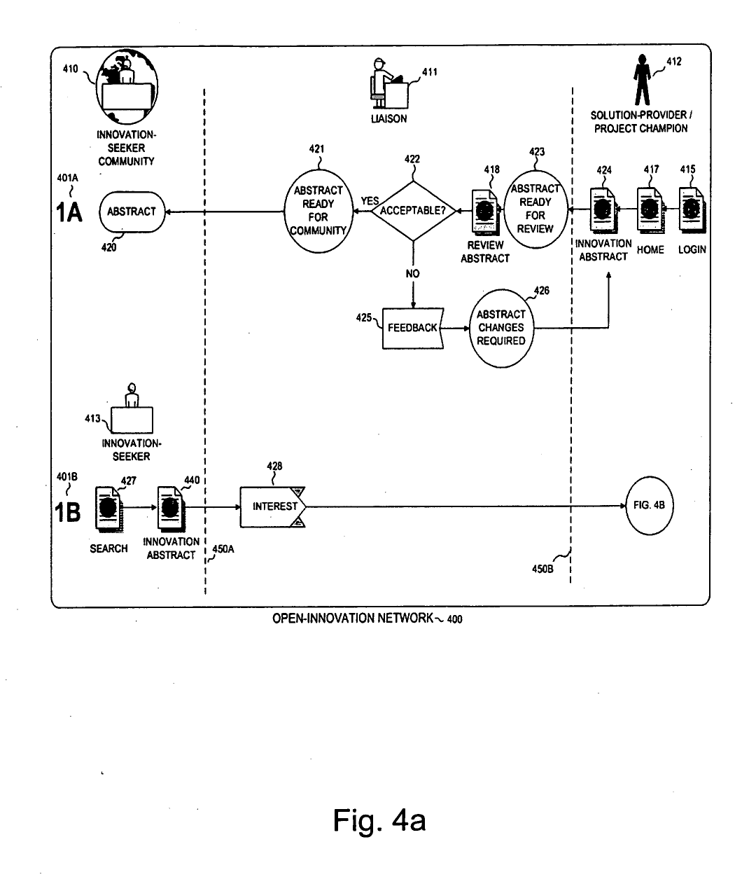

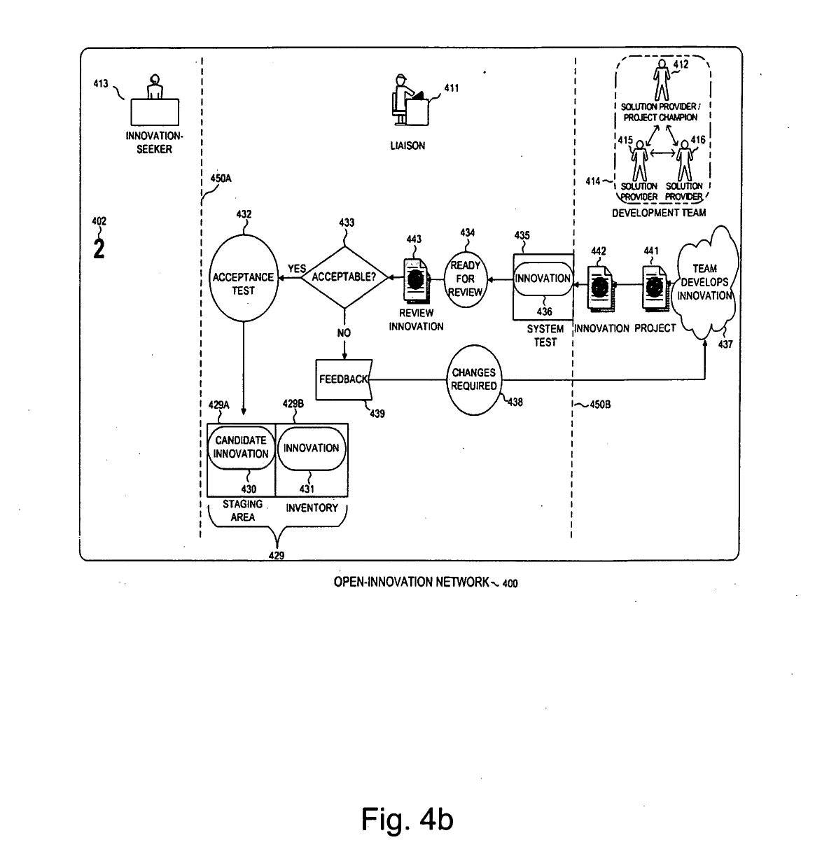

Example 3 is described in connection with FIGS. 4a and 4b. Taken together, FIGS. 4a and 4b depict a flow of operation of an exemplary embodiment of the present invention wherein a Solution-Provider creates a New-to-the-World Innovation. The two straight dotted lines in FIGS. 4a and 4b (450A, 450B) depict a delineation of responsibilities between the Innovation-Seekers 410, 413, the Liaison 411, and the Solution-Providers 412, 415, 416.

As is depicted in FIGS. 4a and 4b, a Solution-Provider 412 may post a New-to-the-World Innovation onto the Open-Innovation Network 400 according to a single-stage process (i.e., Stage 2—identified as 402 in FIG. 4b) which begins when the team develops the Innovation 437).

Optionally, the posting may be a two-stage process comprising Stage 1 (identified as 401A, 401B in FIG. 4a) and Stage 2 (identified as 402 in FIG. 4b). According to this embodiment of the present invention, the Solution-Provider 412 may begin with stage 1A (401A in FIG. 4a) and post a New-to-the-World Innovation abstract and wait for interest in stage 1B (401B in FIG. 4a) from an Innovation-Seeker 413 before continuing to stage 2 (402 in FIG. 4b). Alternatively, the Solution-Provider 412 may begin with stage 2 (402) and post the entire Innovation without first posting an abstract (as may be the case if an Innovation already exists or if the Innovation-Seeker community has already expressed interest in the form of Guidance).

This example describes the entire two-stage process. Beginning with stage 1A (401A), a Solution-Provider 412 navigates the internet to the Login page 415 of the Open-Innovation Network 400. The Solution-Provider 412 logs into the Open-Innovation Network 400 using a previously assigned username and/or password.

Once logged in, the Solution-Provider 412 is presented with the Home page 417, which includes a “New Innovation Abstract” button or link. Next, the Solution-Provider 412 clicks on a “New Innovation Abstract” button or link and is presented with an Innovation Abstract page 424, which may include, but is not limited to, the following exemplary fields:

TABLE
Representative Innovation Abstract page 424

| Field | Field Description |
|---|---|
| Abstract Id | A unique Innovation abstract id. |
| Title | The abstract title |
| Description | A narrative describing the Innovation including its intended use, as well |
| | as the digital type and format in which the Innovation is being offered |
| | (e.g. text, video, animation, or audio files). |
| Terms and | The terms and conditions under which the Innovation is being offered |
| Conditions | (e.g. details of license or purchase agreements), as well as the monetary |
| | amount sought by the Solution-Provider for the unmodified Innovation. |
| | Modifications to the Innovation are negotiated separately. (Note: If this |
| | example depicted the creation of a Solution to a Need-Based Problem, |
| | this field would be pre-populated with the Problem's Terms and Conditions). |
| Problem Id | Blank for this example. This field would otherwise indicate the specific |
| | Need-Based Problem this Innovation is being created to address. |
| Guidance Id | Blank for this example. This field could otherwise indicate the Guidance |
| | id this abstract's Innovation is being created to address. |
| Keywords | Searchable full text keywords that will facilitate the discovery of this |
| | Innovation by Innovation-Seekers. |
| Profile | This will encompass a number of Open-Innovation Network defined |
| (Taxonomy | industry and Innovation specific fields to be used for further |
| Fields) | classifications. |

Fields in italics are system-generated. All others are input by the user.

Once the fields on the Innovation Abstract page 424 are completed or populated, the Solution-Provider 412 clicks on a “Submit” button. At this point, the system places the Innovation Abstract into “Abstract Ready for Review” status 423, and a Liaison 411 with the appropriate expertise (which is determined based primarily on the Abstract's profile as indicated on the Innovation Abstract page 424) is alerted by the system that a new Abstract is awaiting review.

The Liaison 411 logs into the Review Abstract page 418 after receiving the new Abstract alert. The Liaison 411 reviews the abstract to determine if it is “acceptable” by considering criteria including, but not limited to, completeness, clarity and commercial potential.

If the Abstract is deemed unacceptable, the Liaison 411 provides Feedback 425 indicating how the abstract could be made acceptable and clicks on “Not Accepted” button on the Review Abstract page 418. At this point, the system places the abstract into “Abstract Changes Required” status 426 and the system alerts the Solution-Provider 412 that the abstract must be modified before being accepted.

Once alerted that changes are required, the Solution-Provider 412 logs into the Innovation Abstract page 424, which may be pre-populated with abstract values. Once the Solution-Provider 412 completes the necessary changes to the abstract and the Solution-Provider 412 clicks on a “Submit” button on the Innovation Abstract page 424, the system places the abstract back into “Abstract Ready for Review” status 423 and the workflow continues as before.

Once the abstract is deemed acceptable, the Liaison 411 clicks on “Accepted” button on the Review Abstract page 418. At this point, the system places the abstract into “Abstract Ready for Community” status 421, which makes the abstract 420 available to at least a portion of the Innovation-Seeker community 410. One having ordinary skill in the art will appreciate that the Open Innovation Network 400 system functionality may be used to select a particular portion of the Innovation-Seeker community which is particularly suited for review and consideration of the abstract 420. The Intermediary may select this portion of the community based on the nature and type of the innovation.

In Stage 1B (401B), an Innovation-Seeker 413 locates the abstract on the Open-Innovation network 400 by entering relevant search criteria on the Search page 427 and clicking the “Submit” button. The Innovation-Seeker 413 is then presented with a list of abstracts matching the search criteria, wherein each abstract may include summary information. The Innovation-Seeker 413 may then click on one of the results to display more information. At this point, the Innovation-Seeker 413 is presented with a fully-populated Innovation Abstract page 440 which displays the abstract's details including, but not limited to, a title, a description, terms of use, license or sale, award (i.e., the amount the Solution-Provider seeks in exchange for the Solution), a list of keywords, a profile, and a blank feedback text area. Optionally, the Innovation-Seeker 413 may complete the feedback field and clicks “Contact Solution-Provider” on the Innovation Abstract page 440, which prompts the Open-Innovation Network 400 to send a message 428 indicating interest in the abstract to Solution-Provider 412.

One having ordinary skill in the art will appreciate that the abstract may represent either existing Innovations, or conceptualizations of Innovations that do not yet exist, and as such, the workflow may branch in various directions. For example, if the Innovation exists, the Innovation-Seeker may license or purchase the Innovation “as is,” or may pledge to license or purchase the Innovation after agreed upon modifications are completed. Alternatively, if the Innovation does not yet exist, the Innovation-Seeker may pledge to license or purchase the Innovation after its creation. In this example, it is assumed that the Innovation does not yet exist, but that the Innovation-Seeker has pledged to purchase it after its creation.

Referring to FIG. 4b, after the Solution-Provider 412 has been alerted that Innovation-Seeker 413 is interested in the abstract (as demonstrated in FIG. 4a), the process advances to Stage 2 (402). Knowing interest exists, the Solution-Provider 412 initiates a new Project and recruits a Development Team (i.e., a plurality of Solution-Providers 415, 416 capable of performing the Project's or Problems' tasks), and develops a final solution/innovation, as shown in step 437. The solution development process is described in greater detail in Example 4. The Solution-Provider 412 that initiates a new Project is the default Project Champion.

To begin work on the Innovation, the Project Champion 412 clicks on a “New Innovation” button or link on the Project page 441. The Project Champion 412 is then presented with a Innovation page 442 which may include, but is not limited to, the following exemplary fields:

TABLE
Representative Innovation page 442

| Field | Field Description |
|---|---|
| Innovation Id | A unique Innovation id. |
| Title | The Innovation title |
| Description | A narrative describing the Innovation including its intended use, as well |
| | as the digital type and format in which the Innovation is being offered |
| | (e.g. text, video, animation, or audio files). (Note: For this example, this |
| | field would be pre-populated as an abstract was created prior to the |
| | creation of this Innovation.) |
| Terms and | The terms and conditions under which the Innovation is being offered |
| Conditions | (e.g. details of license or purchase agreements), as well as the monetary |
| | amount sought by the Solution-Provider for the unmodified Innovation. |
| | Modifications to the Innovation are negotiated separately. (Note: If this |
| | example depicted the creation of a Solution to a Need-Based Problem, |
| | this field would be pre-populated with the Problem's Terms and |
| | Conditions). |
| Project Id | The id of the specific Project under which this Innovation was created. |
| Abstract Id | This field indicates the specific abstract that was created prior to the |
| | creation of this Innovation. |
| Problem Id | Blank for this example. This field would otherwise indicate the specific |
| | Need-Based Problem this Innovation is being created to address. |
| Guidance Id | Blank for this example. This field would otherwise indicate the |
| | Guidance id this abstract's Innovation is being created to address. |
| Keywords | Searchable full text keywords that will facilitate the discovery of this |
| | Innovation by Innovation-Seekers. |
| Profile | This will encompass a number of Open-Innovation Network defined |
| (Taxonomy | industry and Innovation specific fields to be used for further |
| Fields) | classifications. |

Fields in italics are system-generated. All others are input by the user.

The Project Champion 412 would then populate the Innovation page 442 fields with Innovation details. As part of the Innovation development process, each member of the Development Team 414 (i.e., each Solution-Provider) is assigned a task to complete by the Project Champion 412, based at least in part on the nature of the task and the competencies and/or skills of the Solution Provider. Once the Development Team members 414 have completed their assigned tasks and produced a task solution, the Project Champion 412 clicks the “Send Innovation for System Test” button on the Innovation page 442 to system test the innovation. This action places an electronic copy of the New-to-the-World Innovation 436 into a System Test environment 435 where the Development Team members 414 can ensure the New-To-The-World Innovation 436 is compatible with the System Test environment 435. Example 5 provides a more detailed description of the system-testing process.

Once the New-to-the-World Innovation 436 is compatible with the System Test environment 435 and the Development Team members 414 consider the New-to-the-World Innovation 436 complete, the Project Champion 412 clicks the “Send Innovation for Review” button on the Innovation page 442.

At this point in the process, the system places the Innovation into “Ready for Review” status 434 and a Liaison 411 with the appropriate expertise (which is determined primarily based on the profile indicated on the Innovation page 442) is alerted by the system that a new Innovation is awaiting review.

The Liaison 411 logs into the Review Innovation page 443 after receiving the new Innovation alert and reviews the Innovation to determine if it is acceptable by considering criteria including, but not limited to, completeness, clarity and/or commercial potential.

If the Innovation is deemed unacceptable, the Liaison 411 provides Feedback 439 indicating how the Innovation may be improved and deemed acceptable, and clicks on a “Not Accepted” button on the Review Innovation page 443. Next, the system places the Innovation into “Changes Required” status 438 and the system alerts the Project Champion 412 that the Innovation must be modified before being accepted.

Once alerted that changes are required, the Project Champion 412 logs into the Project page 441, which may be pre-populated with Innovation values and feedback, and assigns tasks to Development Team members 414 to change, modify, or update the Innovation pursuant to the feedback. Once the Development Team members 414 have completed their assigned tasks and provided a refined task solution, system testing is performed. If the refined final solution is deemed acceptable, the Project Champion 412 clicks the “Send Innovation for Review” button on the Innovation page 442. At this point, the system places the Innovation into “Ready for Review” status 434 and the workflow continues as before.

Once the Innovation is accepted, the Liaison 411 clicks on “Accepted” button on the Review Innovation page 443 and the system places the Innovation into “Acceptance Test” status 432. Putting an Innovation into “Acceptance Test” status 432 causes the system to place a copy of the Innovation (now called a Candidate-Innovation 430) onto a Staging Area 429A for examination and assessment by one or more Innovation-Seekers 413. According to an embodiment of the present invention, in the event no Innovation-Seeker 413 is interested in the Candidate-Innovation 430, the system may place a copy of the Innovation 431 into Inventory 429B. Example 6 provides a more detailed description of acceptance-testing of a final solution.

### EXAMPLE 4

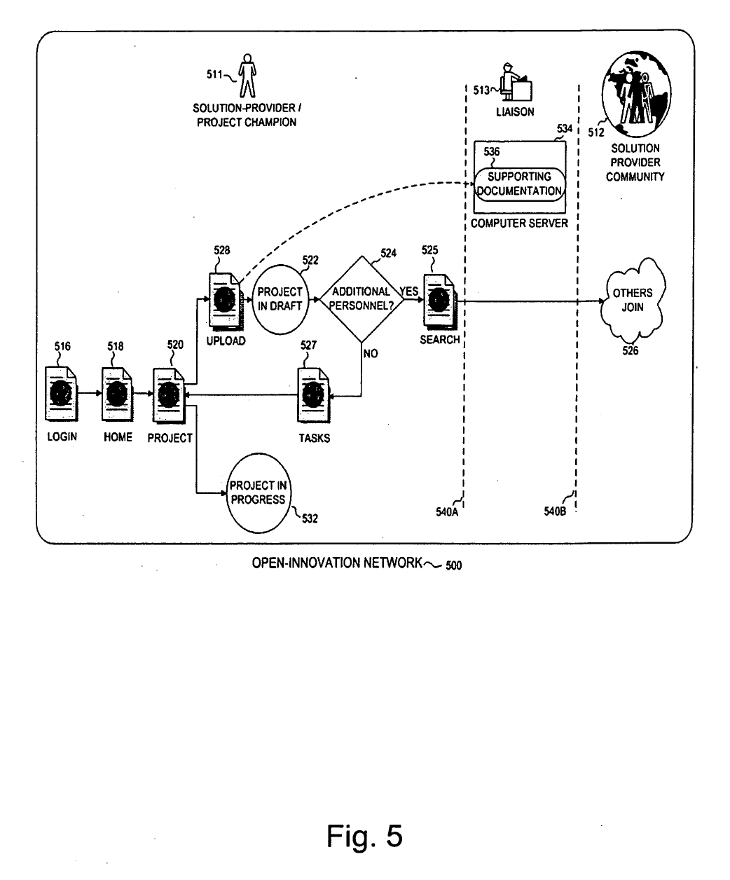

A Solution-Provider may initiate a new Project in response to a request for a solution to a Need-Based Problem or to create a New-to-the-World Innovation. In this example, it is assumed that the Solution-Provider is initiating a new Project to create a New-to-the-World Innovation. This example is described in connection with FIG. 5. FIG. 5 depicts a workflow diagram showing the process flow of an exemplary embodiment of the present invention wherein a Solution-Provider/Project-Champion 511 creates a New-to-the-World Innovation. The two straight dotted lines 540A, 540B depict a delineation of responsibilities between the Solution-Provider/Project-Champion 511, the Liaison 513, and the Solution-Provider Community 512.

As shown in FIG. 5, a Solution-Provider 511 navigates the Internet or other suitable network to a Login page 516 of the Open-Innovation Network 500. Next, the Solution-Provider 511 logs into the Open-Innovation Network 500 using a previously assigned username and/or password.

Once logged in, the Solution-Provider 511 is presented with the Home page 518, which includes a “New Project” button or link. The Solution-Provider 511 clicks on a “New Project” button or link on the Home page 518.

The Project Champion 511 (i.e., Intermediary or designated Solution-Provider) is then presented with a Project page 520 that may include, but is not limited to, the following exemplary fields:

TABLE
Representative Project page 520

| Field | Field Description |
|---|---|
| Project Id | A unique Project id. |
| Title | The Project title. |
| Description | A narrative aimed at current and potential Solution-Providers describing |
| | the Project objectives. |
| Team | The Solution-Providers that have agreed to join the Project team. One or |
| Members | more team members will be designated as Project Champion. |
| Terms and | The terms under which license or purchase remuneration resulting from |
| Conditions | this Innovation will be divided among team members. |
| Start Date | The Project's official start date. |
| End Date | The date by which the resulting Innovation will be completed. (Note: If |
| | this example depicted the creation of a Solution to a Need-Based |
| | Problem, this field would be pre-populated with the Problem's End Date). |
| Problem Id | Blank for this example. This field would otherwise indicate the specific |
| | Need-Based Problem this Innovation is being created to address. |
| Guidance Id | Blank for this example. This field would otherwise indicate the |
| | Guidance id this Innovation is being created to address. |
| Keywords | Searchable full text keywords that will facilitate the discovery of this |
| | Project by Solution-Providers. |
| Profile | This will encompass a number of Open-Innovation Network defined |
| (Taxonomy | industry and Innovation specific fields to be used for further |
| Fields) | classifications. |

Fields in italics are system-generated. All others are input by the user.

The Project Champion 511 then populates the Project page 520 fields with a details relating to the Project. Once the Project page fields 520 have been populated and saved, the system makes the “Upload Supporting Documents” button or link (to upload additional files 536 that further explain the Project onto an Intermediary computer server 534) viewable. The Project Champion 511 clicks on the “Upload Supporting Documents” button or link and is presented with the Upload page 528. Once the Project Champion 511 has completed uploading files 536 (or if he or she chooses not to upload additional files), he or she clicks the “OK” button on the Upload page 528 and the system puts the Project into “Project in Draft” status 522.

If other Development Team members are necessary, the Project Champion 511 may invite the appropriate Solution-Providers to join the Development Team for completion of the Project, as shown in step 524. According to an embodiment of the present invention, the Project Champion 511 invites the other Solution Providers to join the Project by searching keywords and user profile (taxonomy) fields of registered users from the Solution-Provider Community 512 on the Search page 525. Using the search results on the Search page 525, the Project Champion 511 identifies the plurality of qualified Solution Providers, based at least in part on the nature of the tasks of the Project, and invites them to join the Project by clicking the “Send Invitation to Join” button or link next to the appropriate Solution-Provider. This action directs the system to send an electronic message to the Solution-Provider with the Project details and invites the Solution-Provider to join the Project and the selected Solution-Providers join the Project, as shown in step 526.

Once all the required fields on the Project page 520 are populated and the Development Team is complete, the system makes the “Assign Tasks” button or link viewable to allow the Project Champion 511 to assign the tasks to each individual Development Team member. One having ordinary skill in the art will appreciate that the Project Champion 511 may assign one or more tasks to himself or herself, if appropriate.

The Project Champion 511 may then click on the “Assign Tasks” button or link on the Project page 520 to access a Task page 527 that may include, but is not limited to, the following exemplary fields:

TABLE
Representative Task page 527

| Field | Field Description |
|---|---|
| Task Id | A unique task id. |
| Project Id | A Project id to which this task belongs. |
| Title | The task title. |
| Description | A narrative describing the task and objectives. |
| Team | The Solution-Provider that is responsible for completing |
| Member | this task. |
| Start Date | The task's official start date. |
| End Date | The date by which the task must be completed. |

Fields in italics are system-generated. All others are input by the user.

Once the fields have been completed and/or populated and saved on the Task page 527, the Project Champion 511 has the option to assign another task, or to return to the Project page 520.

Once all tasks have been assigned, the Project Champion 511 clicks on the “Submit Project” button or link on the Project page 520 and the system puts the Project in “Project in Progress” status 532, and work on the Project proceeds.

### EXAMPLE 5

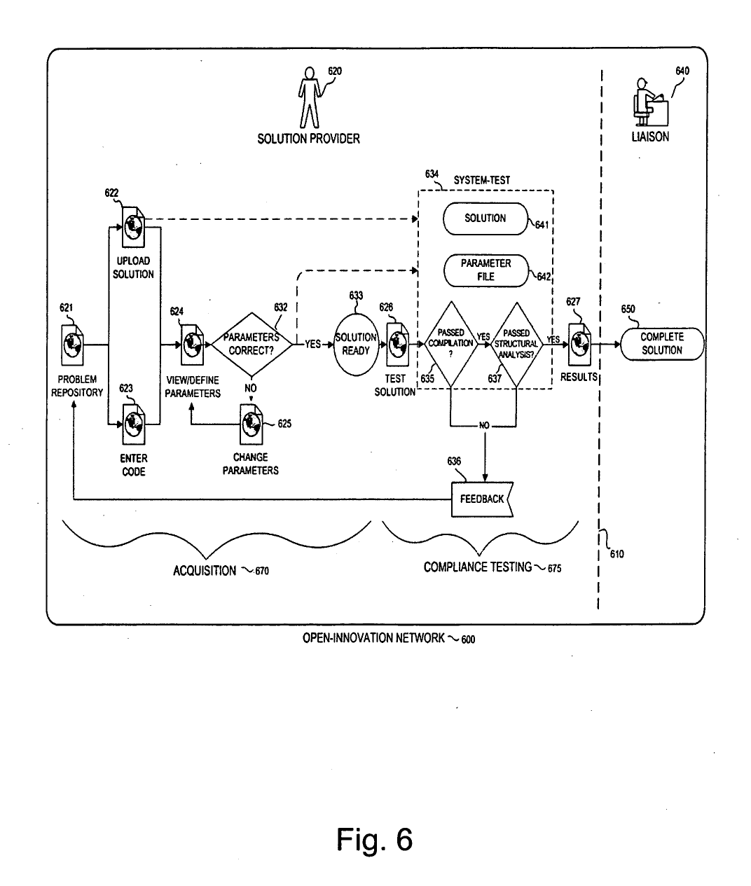

This example is described in connection with FIG. 6. FIG. 6 depicts a process flow of an exemplary embodiment of the present invention wherein a Solution-Provider system-tests a Solution (which in this example is a Java computer program) to a previously defined Innovation-Seeker problem. In FIG. 6, the straight dotted line 610 depicts a delineation of responsibilities between the Solution-Provider 620 and the Liaison 640.

System-testing is a function performed on the Open-Innovation Network 600, and involves a Solution-Provider 620 submitting an Innovation through a series of tests to determine whether the Innovation can be run within the Open-Innovation Network 600. According to an embodiment of the present invention, one or more of the Solution Providers performs the system-testing.

Performing the system-tests ensures that the Innovation conforms to a given set of standards defined by the Open-Innovation Network 600, and creates a single deliverable item (e.g., a set of digital files), which can easily be transferred and executed on different systems running a similar environment.

According to an embodiment of the present invention, system-testing is divided into two parts: Acquisition 670 (i.e., the process of obtaining the Innovation from the Solution-Provider) and Compliance Testing 675 (i.e., the process of determining the integrity and validity of the acquired Innovation).

As shown on FIG. 6, for this example, Acquisition 670 begins with the Solution-Provider 620 initiating the Innovation system-testing process from within the Problem Repository page 621. One having ordinary skill in the art will appreciate that Innovations not associated with a specific problem may be initiated from a different, albeit similar page. In this example, the Solution-Provider 620 is system-testing an Innovation that is associated with a specific problem. Thus, the Innovation is referred to as a “Solution” for the remainder of the example.

The Problem Repository page 621 lists different problems that have been previously defined by Innovation-Seekers (not shown). From within the Problem Repository page 621, the Solution-Provider 620 has a choice of submitting an existing Solution from within his or her computer or writing a Solution directly from within the web browser (the latter option is most appropriate for less complicated Solutions that do not require changes to the Open-Innovation Network's 600 default data access routines).

Choosing to submit an existing Solution brings the Solution-Provider 620 to the Upload Solution page 622, which contains an “Upload” button and file browser field. The Solution-Provider 620 selects the Solution from within his computer system and clicks on the ‘Upload’ button to upload the Solution 641 (i.e., a set of digital files) to System Test 634. The system then presents the Solution-Provider 620 with the View/Define Parameters page 624.

The View/Define Parameters page 624 shows the current Solution 641 parameters contained within a Parameter file (for this example, the Input Data Structure and Output Data Structure parameters were previously defined by the Innovation-Seeker). The following table sets forth an exemplary Parameter file, according to an embodiment of the present invention:

TABLE
Exemplary Parameter File

| Parameter | Parameter Description |
|---|---|
| Innovation Id | A unique Innovation Id. |
| Problem Id | A problem id that associates the Innovation to a specific, predefined problem - |
| | as is the case with this example. A unique problem id is system-generated every |
| | time an Innovation-Seeker submits a problem to the Open-Innovation Network |
| | 600. This field would be empty if the Solution-Provider were submitting a |
| | New-to-the-World Innovation. |
| Class Name | For this example, the Java class name of the Innovation submitted. |
| Title | A generic and descriptive Innovation name, than is provided with the Class |
| | Name. |
| Description | A description of the Innovation, which may include a simple explanation of |
| | how it works or more detailed information. |
| Input Data | A collection of input file structures describing the number and type of input |
| Structure | data sources to the Innovation. |
| | This structure may be defined a number of ways, including: system-generated |
| | based on data submitted by the Innovation-Seeker when defining the problem, |
| | or based on data used by the Solution-Provider when developing the |
| | Innovation. This structure may also be manually defined by the Innovation- |
| | Seeker or by the Solution-Provider. |
| Output Data | Similar to above, a collection of output file structures describing the number |
| Structure | and type of output data returned by the Innovation. |

Parameters in italics are system-generated. All others are input by the user.

In this example, the View/Define Parameters page 624 includes, but is not limited to, ‘Save Changes’ and ‘Next’ buttons, and presents the Input and Output Data Structure information previously defined for the problem by the Innovation-Seeker (not shown).

Clicking the ‘Save Changes’ button on the View/Define Parameters page 624 saves changes to the Input and Output Data Structure information to the Parameter file. Clicking the ‘Next’ button the View/Define Parameters page 624 initiates a parameters check. If the Solution-Provider 620 made changes to the data specifications that had been previously defined by the Innovation-Seeker and/or if the parameters are not correct 632, the Solution-Provider 620 must define and/or correct the parameters through the Change Parameters page 625, and may repeat through several cycles until the parameters have been completely and correctly defined.

According to an embodiment of the present invention, if the Solution-Provider 620 decides to enter the Solution directly from within the web browser (not shown in this example), he or she may be directed to the Enter Code page 623, which contains a multi-line text field where he or she can enter the Solution. According to an embodiment of the present invention, two buttons are presented on the Enter Code page 623: ‘Save Changes’ and ‘Next’. The ‘Save Changes’ function allows the Solution-Provider 620 to save changes to the Solution to System Test 634. By clicking on the ‘Next’ button, the Solution-Provider 620 is directed to the View/Define Parameters page 624.

Once the Solution's parameters have been completely defined and are correct, clicking on the ‘Next’ button on the bottom of the View/Define Parameters page 624 initiates the transfer of the Parameter file 642 to the System Test 634. At this point the Solution 641 has reached the Solution Ready state 633, at which point it is ready for Compliance Testing 675.

The Solution-Provider 620 is then presented with the Test Solution 626 page, which contains a ‘Test’ button and a message indicating that the Solution 641 is ready for Compliance Testing 675.

According to an embodiment of the present invention, Compliance Testing 675 comprises a series of operations that determine the integrity and validity of the acquired Solution 641, and is divided into two major stages: Compilation 635 and Structural Analysis 637. The Compilation 635 stage determines the standards compliance of the Solution 641 and detects any coding errors. The Structural Analysis 637 stage tests the structure of the compiled Solution 641 and compares it to what is defined in the associated Parameter file 642.

Once the Solution-Provider 620 clicks on the Test Solution 626 page's ‘Test’ button, the system processes the Solution 641 through the first phase of the system-testing process: Compilation 635. If a Solution 641 does not compile, it means that it was not inherited from a predefined Java base class (for this example), or that the source code has syntactical errors. These errors are then visually presented via Feedback 636 (e.g., a detailed error page) to the Solution-Provider 620 for review, edit and re-submission of the Solution.

Once the Solution 641 passes Compilation 635 (that is, the Solution 641 compiles and is free of syntactical errors), the second phase of the system-testing process, Structural Analysis 637, takes place. The Structural Analysis stage tests the structure of the compiled Solution 641 and compares it to what is defined in the associated Parameter file 642.

For this example, the Solution 641 is loaded as an instance of the Java base class, again to make sure it was inherited from the standard base Java class. Then the system analyzes the instantiated Solution 641, checking that the number and type of inputs and outputs used by the source code match the specifications defined in the Parameter file 642. If any errors are detected, they are again reported back to the Solution-Provider 620 through Feedback 636 (i.e., the compiler error is redirected to the screen).

Once the Solution 641 passes the Structural Analysis 637 stage, the Solution-Provider 620 is informed via the Results page 627. From here, the Solution-Provider is presented with the option to post the Solution 650 for the Liaison 640 to review.

### EXAMPLE 6

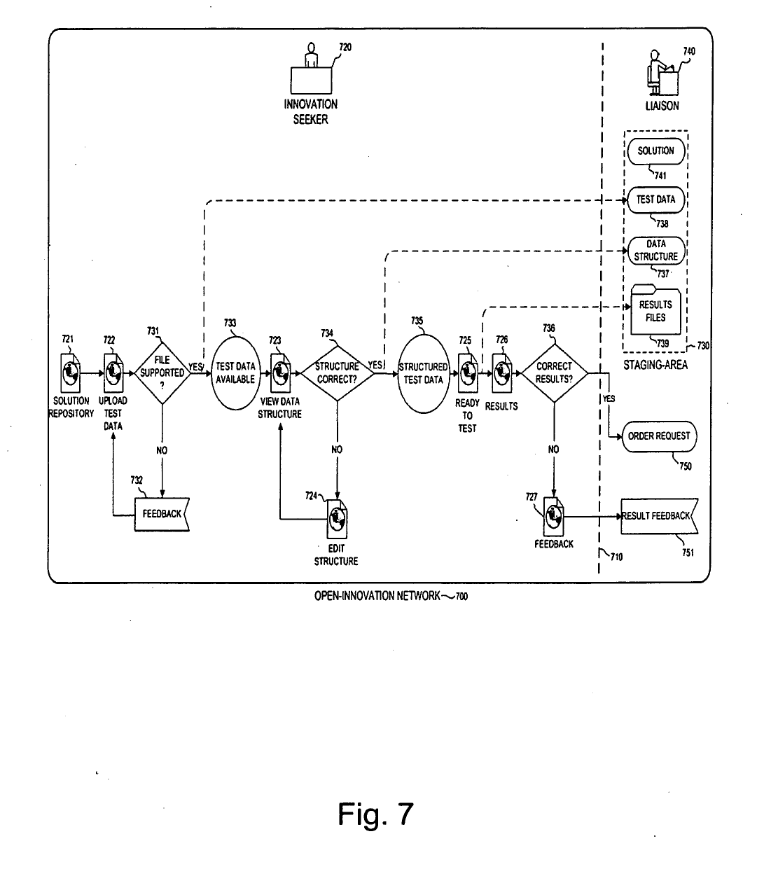

This example is described in connection with FIG. 7. FIG. 7 depicts an exemplary process flow of an embodiment of the present invention wherein an Innovation-Seeker performs acceptance-testing on a Solution-Provider's Solution.

After a Solution has been created and system-tested by a plurality of Solution-Providers (as described in Example 5), it is made available for acceptance-testing in the Staging Area 730 by one or more Innovation-Seekers on the Open-Innovation Network 700.

The purpose of acceptance-testing is for Innovation-Seekers to determine whether a particular Innovation meets criteria set forth by a predefined problem, and/or is otherwise commercially valuable. Generally, Innovation-Seekers acceptance-test an Innovation by submitting data to the Staging Area 730, running the data through the Solution, and analyzing the results.

The following describes a flow of operation wherein an Innovation-Seeker acceptance-tests a Solution-Provider's Solution (which is a Java computer program in this example). The straight dotted line 710 shown in FIG. 7 depicts a delineation of responsibilities between the Innovation-Seeker 720 and the Liaison 740.

As shown on FIG. 7, for this example, acceptance-testing begins with the Innovation-Seeker 720 initiating the process from within the Solution Repository page 721. The Solution Repository page 721 contains a list of problems and associated Solutions (note: Innovations not associated with a specific problem would be initiated from a different, albeit similar page).

From the Solution Repository page 721, the Innovation-Seeker 720 selects a Solution to be tested by (for instance) double-clicking on the Solution. Once a Solution is selected, the Innovation-Seeker 720 is directed to the Upload Test Data page 722, which contains a file browser field to select Test Data from his computer or computer network (for this example).

According to an embodiment of the present invention, the Innovation-Seeker 720 may upload various types of data for testing, from a simple comma-separated value (CSV) file to binary data files taken directly from database management systems. For data that originates from databases, data readers that interface directly with the databases streamline the acceptance-testing process by requiring minimal amounts of data massaging.

After choosing Test Data, the Innovation-Seeker 720 clicks on an ‘Upload’ button on the Upload Test Data page 722 to continue with the process. If the Test Data file is supported by the system 731, the Test Data 738 is uploaded into the Staging Area 730. As the Test Data 738 is uploaded, the system converts the raw data to a standardized structure, which may be generically processed by the Solutions, regardless of the original format. To do this, the system determines the file type and format, and initiates the appropriate file reader to process the data format. Another (data-type specific) system process then analyzes the data in order to determine its structure—thereby minimizing data conversion problems caused by human error.

For example, delimited values are determined due to the frequency of certain delimiters, such as, for example, commas, tabs, or other like symbols. Eventually, the process yields a simple description of the data in terms of column headers and column data types.

If the uploaded Test Data 738 is either not in the correct format (i.e., corrupted) or unsupported, a Feedback 732 is sent back to the Innovation-Seeker 720 indicating problems with the data analysis process. The Innovation-Seeker 720 is then presented with an Upload Test Data page 722 so that he or she may re-upload the Test Data or upload another set of data.

Once the system recognizes the type and structure of the uploaded Test Data 738, the system places the Solution into a Test Data Available state 733, and the structure of the Test Data 738 (as determined by the system) is displayed on the View Data Structure page 723. Here, the Innovation-Seeker 720 has a chance to review the resulting structure of the Test Data 738 and make changes if there are any errors. The Innovation-Seeker 720 then determines if the data's structure is correct 734. If the structure is not correct, the Innovation-Seeker 720 clicks on the “Edit” button that appears on the View Data Structure page 723. The Innovation-Seeker 720 is then presented with the Edit Structure page 724 to make corrections to the structure of the Test Data 738.

Once corrections are complete, the Innovation-Seeker 720 clicks on the “Complete” button and is presented with the View Data Structure page 723. From the View Data Structure page 723, the Innovation-Seeker 720 clicks on the ‘Next’ button when the structure of the Test Data 738 has been correctly defined. The system then saves a Data Structure file 737 to the Staging Area 730, and places the Solution into a Structured Test Data state 735, indicating data is now available to acceptance-test the Solution, as well as a data definition file (i.e., Data Structure file 737) describing how to access the Test Data 738.

The Innovation-Seeker 720 is then presented with the Ready To Test page 725. Clicking on the ‘Test Solution’ button from this page causes the system to load the Solution 741 into memory of the Staging Area 730. Then, using the Data Structure file 737, the system inputs the Test Data 738 into the Solution 741. Optionally, because some Solutions may take longer to complete (e.g., five seconds or more, depending on the amount of test data and complexity of the Solution), an animated progress indicator of colored bars scanning across a page along with instructions not to interrupt the process is displayed.

Once the Solution 741 has completed its execution, a portion of the results is displayed on the Results page 726, and the full Results Files 739 are saved onto the Staging Area 730. Optionally, in the event the output of the Solution is large, only the first few data results (e.g., fifty or less) may be displayed on the Results page 726, and appear as colored tables with column headers clearly marked and rows in alternating light and dark colors for better readability. The full Results Files 739 may be accessed from the Staging Area 730 by the Innovation-Seeker 720 as downloadable files in several standard formats including compressed file formats such as, for example, in a ZIP or RAR file formats.

The Innovation-Seeker 720 can then analyze results and confirm the correctness 736 of the Solution 741. If the results are correct, the Innovation-Seeker 720 clicks on the “Correct” button at the bottom of the Results page 726, thereby confirming the Solution 741 has completed the acceptance-test process. At this point, the Solution 741 is marked as ‘valid,’ and the Innovation-Seeker 720 is presented with an option to purchase the Solution 741. If he or she chooses to do so, an Order Request 750 is sent to the Liaison 740. If the Innovation-Seeker 720 does not wish to purchase the Solution 741 at this time, the Solution 741 remains available through the Solution Repository 721.

Alternatively, if the Solution results are erroneous or inconsistent, the Innovation-Seeker 720 may click on the ‘Deny’ link at the bottom of the Results page 726. The Innovation-Seeker 720 may then be directed to a Feedback form 727 to leave comments about the failure of the Solution 741. This Result Feedback 751 is eventually sent back to the Solution-Provider (i.e. the creator of the Solution 741—not shown here) as insight on how to further refine the Solution 741.

Section 3: An Exemplary System Architecture of the Invention

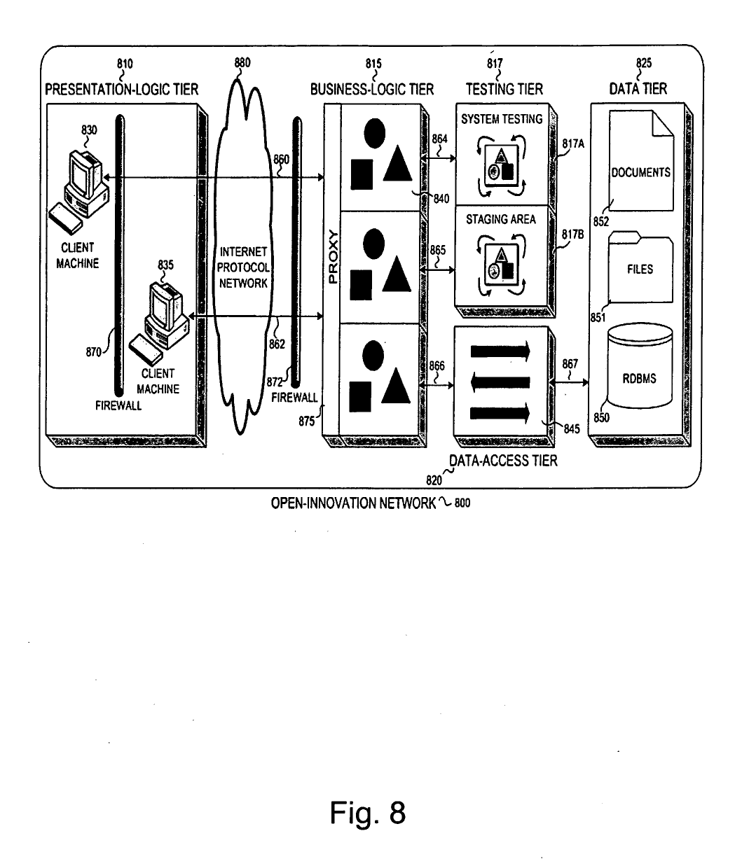

An exemplary system architecture of the invention is described below in connection with FIG. 8. According to an embodiment of the present invention, the Open-Innovation Network system 800 may be comprised at least in part of off-the-shelf software components and industry standard multi-tier (a.k.a. “n-tier”, where “n” refers to the number of tiers) architecture designed for enterprise level usage. One having ordinary skill in the art will appreciate that a multi-tier architecture includes a user interface, functional process logic (“business rules”), data access and data storage which are developed and maintained as independent modules, most often on separate computers.

According to an embodiment of the present invention, the system architecture of the Open-Innovation Network 800 comprises a Presentation Logic Tier 810, a Business-Logic Tier 815, a Testing Tier 817, a Data-Access Tier 820, and a Data Tier 825.

The Presentation Logic Tier 810 (sometimes referred to as the “Client Tier”) comprises the layer that provides an interface for an end user (i.e., an Innovation-Seeker and/or a Solution-Provider) into the application (e.g., session, text input, dialog, and display management). That is, the Presentation Logic Tier 810 works with the results/output 860, 862 of the Business Logic Tier 815 to handle the transformation of the results/output 860, 862 into something usable and readable by the end user's client machine 830, 835. Optionally, a user may access the Open-Innovation Network system 800 using a client machine 830 that is behind a firewall 870, as may be the case in many user environments.

The Open-Innovation Network system 800 uses Web-based user interfaces, which accept input and provide output 860, 862 by generating web pages that are transported via the Internet through an Internet Protocol Network 880 and viewed by the user using a web browser program on the client's machine 830, 835.

According to an embodiment of the present invention, the Presentation Logic Tier 810 may also include a proxy 875 that is acting on behalf of the end-user's requests 860, 862 to provide access to the Business Logic Tier 815 using a standard distributed-computing messaging protocol (e.g., SOAP, CORBA, RMI, DCOM). The proxy 875 allows for several connections to the Business Logic Tier 815 by distributing the load through several computers. The proxy 875 receives requests 860, 862 from the Internet client machines 830, 835 and generates html using the services provided by the Business Logic Tier 815.

The Business Logic Tier 815 contains one or more software components 840 for business rules, data manipulation, etc., and provides process management services (such as, for example, process development, process enactment, process monitoring, and process resourcing).

In addition, the Business Logic Tier 815 controls transactions and asynchronous queuing to ensure reliable completion of transactions, and provides access to resources based on names instead of locations, and thereby improves scalability and flexibility as system components are added or moved. The Business Logic Tier 815 works in conjunction 866 with the Data Access Tier 820 to manage distributed database integrity. The Business Logic Tier 815 also works in conjunction 864, 865 with the Testing Tier 817 to assess Innovations and examine results.

Optionally, according to an embodiment of the present invention, the Business Logic Tier 815 may be located behind a firewall 872, which is used as a means of keeping critical components of the Open-Innovation Network 800 secure. That is, the firewall 872 may be used to filter and stop unauthorized information to be sent and received via the Internet-Protocol network 880.

According to an embodiment of the present invention, the Testing Tier 817 is composed of two computer environments: System Test 817A and Staging Area 817B. The System Test area 817A is a computing environment wherein Solution-Providers assess Innovations for Open-Innovation Network 800 computer system compatibility. The Staging Area 817B is a computing environment wherein Innovation-Seekers run Innovations and examine results to ensure said Innovations meet predefined criteria or are otherwise commercially valuable.

Access 864, 865 to the Testing Tier 817 is strictly controlled and coordinated by functionality found in the Business Logic Tier 815, without any direct interaction with Solution-Providers or Innovation-Seekers.

Software components 840 in the Business Logic Tier 815 determine what is moved to Testing Tier 817 and what actions are performed. For example, an Innovation-Seeker that needs to acceptance-test a particular Innovation may specify the Innovation and associated data—software components 840 in the Business Logic Tier 815 that manage the loading of the correct Innovation, accessing the necessary data 866 from the RDBMS 850, and running the Innovation in the Staging Area 817B environment.

According to an embodiment of the present invention, the Testing Tier 817 is situated on a different computer from the Business Logic Tier 815 for added performance and security.

From a performance perspective, separate computers dedicated to testing and executing/running Innovations provides several benefits. Testing Innovations may be computer-processor intensive, thus requiring higher-performance for the Testing Tier 817 than for the Business Logic Tier 815. In addition, by isolating complex Innovations within the Testing Tier 817 environment, a high priority to execute code may be assigned and access may be granted to all the system resources required in order to perform calculations.

Isolating the Testing Tier 817 on a separate computer server also provides a cushion of security from potential damage to the entire Open-Innovation Network 800 that could be caused by incorrectly, or maliciously coded Innovations. Testing Tier 817 isolation minimizes the risk such failures may affect the entire Open-Innovation Network 800.

The Data-Access Tier 820 is a reusable interface that contains generic methods 845 to manage the movement 867 of Data 850, Documentation 852, and related files 851 to and from the Data Tier 825. The Data-Access Tier 820 contains no data or business rules, other than some data manipulation/transformation logic to convert raw data files into structured data that Innovations may use for their calculations in the Testing Tier 817.

The Data Tier 825 is the layer that contains the Relational Database Management System (RDBMS) 850 and file system (i.e., Documentation 852, and related files 851) and is only intended to deal with the storage and retrieval of information. The Data Tier 825 provides database management functionality and is dedicated to data and file services that may be optimized without using any proprietary database management system languages. The data management component ensures that the data is consistent throughout the distributed environment through the use of features such as data locking, consistency, and replication. As with the other tiers, this level is separated for added security and reliability.

It is to be understood that the exemplary embodiments are merely illustrative of the invention and that many variations of the above-described embodiments may be devised by one skilled in the art without departing from the scope of the invention. It is therefore intended that all such variations be included within the scope of the following claims and their equivalents.

What is claimed is:

1. An open-innovation network for facilitating the creation of digital media at the request of an innovation-seeker, comprising:
an intermediary communicatively connected to the innovation-seeker; and
a project-champion communicatively connected to the intermediary,
wherein the intermediary is configured to:
receive a request for the creation of digital media from the innovation-seeker, provide the request to the project champion,
receive a final solution comprising the requested digital media from the project champion,
facilitate the innovation-seeker's acceptance of the final solution, wherein the project-champion:
divides the request into the plurality of tasks,
based at least on the nature of each task, assigns each task to a solution-provider capable of performing the task to produce a plurality of task solutions,
performs system testing to confirm interoperability of the task solutions, and
combines the plurality of task solutions into the final solution.

2. The network of claim 1, wherein the intermediary may provide a toolset for the creation of the final solution to at least one of the project champion and the plurality of solution-providers.

3. The network of claim 1, wherein the intermediary facilitates an exchange of the final solution between the innovation-seeker and project-champion.

4. The network of claim 1, wherein the project-champion performs at least one task.

5. The network of claim 1, wherein the intermediary provides feedback to the innovation-seeker regarding the request for the creation of digital media.

6. The network of claim 5, wherein the request is refined by the innovation-seeker based at least in part on the feedback.

7. A method for facilitating the creation of digital media by a plurality of solution-providers at the request of an innovation-seeker, comprising the steps of:
receiving a request for the creation of digital media from the innovation-seeker;
dividing the request into the plurality of tasks;
based at least on the nature of each task, assigning a solution-provider capable of performing at least one task to develop at least one task solution for each task;
receiving the developed task solutions from the assigned solution-providers;
performing system testing to confirm interoperability of the developed task solutions;
combining the produced task solutions into a final solution; and
facilitating the innovation-seeker's acceptance of the final solution.

8. The method of claim 7, further comprising the step of providing the innovation-seeker with feedback regarding the request.

9. The method of claim 8, further comprising the step of receiving an updated request refined based at least in part on the feedback.

10. An open-innovation network for facilitating the exchange of a new-to-the-world innovation including digital media between at least one innovation-seeker and a plurality of solution providers collaborating to create the new-to-the-world innovation, the network comprising:
an intermediary communicatively connected to the at least one innovation-seeker, wherein the intermediary is configured to:
receive a guidance from the at least one innovation-seeker,
receive the new-to-the-world innovation from the communicatively connected plurality of solution-providers,
identify an innovation-seeker seeking the new-to-the-world innovation based on a comparison of the guidance and the new-to-the-world innovation, and
facilitate the exchange of the new-to-the world innovation between the plurality of solution providers and the identified innovation-seeker.

11. The network of claim 10, wherein the intermediary provides feedback regarding the guidance to at least one innovation-seeker.

12. The network of claim 10, wherein the intermediary facilitates the identified innovation-seeker's acceptance of the new-to-the-world innovation.

13. The network of claim 10, wherein the intermediary provides feedback to at least one of the plurality of solution-providers regarding the new-to-the-world innovation.

14. A method for exchanging digital media, comprising the steps of:
receiving a guidance from at least one innovation-seeker,
receiving the new-to-the-world innovation from the communicatively connected plurality of solution-providers,
identifying an innovation-seeker seeking the new-to-the-world innovation based on a comparison of the guidance and the new-to-the-world innovation; and
facilitating the exchange of the new-to-the world innovation between the plurality of solution providers and the identified innovation-seeker.

15. The method of claim 14, further comprising the step of providing feedback regarding the guidance to the at least one innovation-seeker.

16. The method of claim 14, further comprising the step of facilitating the identified innovation-seeker's acceptance of the new-to-the-world innovation.

17. The method of claim 14, further comprising the step of providing feedback to at least one of the plurality of solution-providers regarding the new-to-the-world innovation, wherein the feedback facilitates acceptance of the new-to-the-world innovation by the identified innovation-seeker.
